(19) United States
(12) Patent Application Publication
(10) Pub. No.: US 2025/0021761 A1
(43) Pub. Date: Jan. 16, 2025

(54) ACCELERATING INFERENCING IN GENERATIVE ARTIFICIAL INTELLIGENCE MODELS

(71) Applicant: QUALCOMM Incorporated, San Diego, CA (US)

(72) Inventors: Arvind Vardarajan SANTHANAM, San Diego, CA (US); Joseph Binamira SORIAGA, San Diego, CA (US); Roland MEMISEVIC, Toronto (CA); Mingu LEE, San Diego, CA (US); Christopher LOTT, San Diego, CA (US)

(21) Appl. No.: 18/545,804

(22) Filed: Dec. 19, 2023

Related U.S. Application Data
(60) Provisional application No. 63/513,488, filed on Jul. 13, 2023.

(51) Int. Cl. G06F 40/284

(52) U.S. Cl. CPC G06F 40/284

(57) ABSTRACT

Techniques and apparatus for generating a response to a query input into a generative artificial intelligence model. An example method generally includes generating, based on an input query and a first generative artificial intelligence model, a sequence of tokens corresponding to a candidate response to the input query. The sequence of tokens and the input query are output to a second generative artificial intelligence model for verification. One or more first guidance signals for the generated sequence of tokens are received from the second generative artificial intelligence model. The candidate response to the input query is revised based on the generated sequence of tokens and the one or more first guidance signals, and the revised candidate response is output as a response to the received input query.

### CROSS-REFERENCE TO RELATED APPLICATIONS

This application claims priority to and benefit of U.S. Provisional Patent Application Ser. No. 63/513,488, entitled “Accelerating Inferencing in Generative Artificial Intelligence Models,” filed Jul. 13, 2023, and assigned to the assignee hereof, the entire contents of which are hereby incorporated by reference.

### INTRODUCTION

Aspects of the present disclosure relate to generative artificial intelligence models, and more specifically to speculative decoding in generative artificial intelligence models.

Generative artificial intelligence models can be used in various environments in order to generate a response to an input query. For example, generative artificial intelligence models can be used in chatbot applications in which large language models are used to generate an answer, or at least a response, to an input query. Other examples in which generative artificial intelligence models can be used include (but are not limited to): (i) a latent diffusion model, in which a model generates an image from an input text description of the content of the desired image, (ii) transformer neural networks, in which inputs are encoded into and decoded out of a latent space using an attention mechanism, and (iii) decision transformers, in which future actions are predicted based on sequences of prior actions within a given environment.

Generally, generating a response to a query (also referred to as a prompt) using generative artificial intelligence models may be computationally expensive. For example, in a chatbot deployment in which a large language model is used to generate a response to a query (prompt) formatted as a text query (prompt), a response to the query (prompt) may be generated using a pass through the large language model for each token (e.g., word or part of word) generated as part of the response. The output of each pass may be a probability distribution on a sequence of tokens (words or parts of words) from which the next token (word or part of word) may be selected, either by sampling or based on maximum likelihood. Because a pass through a large language model is used to generate each token in a response to a query (prompt), the computational expense may be modeled as the product of the number of words included in the response and the computational resource expense (e.g., in terms of processing power, memory bandwidth, or other compute resources used) of performing a pass through the large language model, which generally increases as the number of parameters within the large language model increases.

### BRIEF SUMMARY

Certain aspects of the present disclosure provide a method for generating a response to an input query using a generative artificial intelligence model. The method generally includes generating, based on an input query and a first generative artificial intelligence model, a sequence of tokens corresponding to a candidate response to the input query; receiving, from a second generative artificial intelligence model, a response based on the generated sequence of tokens and one or more guidance signals for the generated sequence of tokens; and outputting a response to the input query based on the generated sequence of tokens and the one or more guidance signals

Certain aspects of the present disclosure provide a method for generating a response to an input query using a generative artificial intelligence model. The method generally includes receiving, at a first generative artificial intelligence model, an input for which a second generative artificial intelligence model is to generate a response; generating, using the first generative artificial intelligence model, one or more guidance signals for the input, the one or more guidance signals identifying actions to be performed by the second generative artificial intelligence model to generate the response; and outputting the one or more guidance signals to the second generative artificial intelligence model to trigger generation of the response by the second generative artificial intelligence model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example computing environment in which queries are iteratively processed using different devices within the computing environment, according to aspects of the present disclosure.

FIG. 2 is a state diagram illustrating operations for generating a corrected response to an input query using generative artificial intelligence models, according to aspects of the present disclosure.

FIG. 3 illustrates an example of generating corrective signals for a draft response to an input query, according to aspects of the present disclosure.

FIG. 4 illustrates example operations for training a generative artificial intelligence model to generate corrective signals for a draft response to an input query, according to aspects of the present disclosure.

FIG. 5 illustrates example operations for generating a response to an input query using generative artificial intelligence models, according to aspects of the present disclosure.

FIG. 6 illustrates example operations for generating a corrected response to an input query using generative artificial intelligence models, according to aspects of the present disclosure.

FIG. 7 illustrates example operations for generating guidance signals for a generative artificial intelligence model to use in generating a response to an input query, according to aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models. The term “generative artificial intelligence model” may be used interchangeably with the term “generative model” throughout the present disclosure. Likewise, the terms “target artificial intelligence model” and “draft artificial intelligence model” may be used interchangeably with the terms “target model” and “draft model,” respectively, throughout the present disclosure. The term “query” may also be used interchangeably with the term “prompt” throughout the present disclosure.

Generally, generative artificial intelligence models generate a response to a query input into the model. For example, a large language model deployed within a chatbot can generate a response to a query using multiple passes through the large language model, with each successive pass being based on the query and the tokens (or words) generated using previous passes through the large language model. Generally, these large language models may include millions, or even billions, of weights or parameters within the model. Because of the size of these models and the operations performed on each token to predict what should be the next token generated in response to a query and the previously generated tokens, it may not be practical, or even possible, to deploy large language models on a variety of devices which may have limited memory, storage, and/or processing capabilities relative to a cloud compute instance on which a large language model typically operates. Further, the computational complexity involved in generating a response to a query provided as input into a model may involve significant energy expenditure, processing time, memory utilization, and other resource utilization which may make compute resources unavailable for use in performing other tasks.

To improve the efficiency and throughput of generative artificial intelligence models, speculative decoding techniques allow for a smaller generative artificial intelligence model, sometimes known as a draft model (e.g., a draft large language model in aspects where the generative artificial intelligence model is a large language model used to generate textual responses to an input query), to execute in collaboration with a larger generative artificial intelligence model, sometimes known as a target model (e.g., a target large language model in aspects where the generative artificial intelligence model is a large language model used to generate textual responses to an input query). In such a case, the draft model, which may be a pruned version of the target model chosen such that the draft model and target model have similar probability distributions, can generate speculatively additional tokens and probabilities used for sampling these additional tokens based on a current set of accepted tokens. The target model can generate tokens based on the tokens generated by the draft model. To generate a result, the target model can perform rejection sampling on a per-token basis to accept or reject tokens generated by the draft model such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or even billions of tokens).

Aspects of the present disclosure provide techniques for generating responses to a query input into a generative artificial intelligence model, such as a large language model, using a draft model and a target model. Generally, the draft model can generate a candidate response to the query. The target model, in turn, can generate guidance signals that the draft model can use to generate a correct response to the query. Generally, a correct response may be a response that is semantically correct or is otherwise a semantic match to a query that the target model would generate. These guidance signals may include, for example, corrections to the candidate response generated by the draft model, information identifying that portions of a candidate response are incorrect and information that the draft model can use to generate a corrected response, information identifying tasks for the draft model to perform in generating a corrected response, or the like. By using a target model to generate guidance signals to aid a draft model in generating a response to an input query, aspects of the present disclosure can generate accurate responses using fewer compute resources than the amount of compute resources used by generative artificial intelligence models that iteratively generate candidate responses based on verification by another generative artificial intelligence model and can allow computing resources to remain available for processing other queries using generative artificial intelligence models or for other tasks executed on computing systems on which generative artificial intelligence models are deployed.

### Decoding Tokens in Generative Artificial Intelligence Models

Generally, autoregressive token generation (e.g., in large language models) may take historical tokens as an input in order to generate an output. That is, autoregressive token generation may be represented by the expression:

$${x}_{t} ∼ p ( x \vert {x}_{0} , {x}_{1} , … , {x}_{t - 1} ) \to {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates a sequence of tokens, with the target model being used to verify the sequence of tokens (speculatively) generated by the draft model.

In a speculative decoding pipeline, the draft model may speculatively generate a sequence of n tokens autoregressively, according to the expression:

$${x}_{t + 1}^{draft} ∼ {p}_{t}^{draft} = {p}^{draft} ( x \vert {x}_{0} , … {x}_{t} ) , {x}_{t + 2}^{draft} ∼ {p}_{t + 1}^{draft} , … , {x}_{t + n}^{draft} ∼ {p}_{t + n - 1}^{draft}$$

where t corresponds to a point in time and pₜ^{draft} corresponds to the conditional probability distribution associated with a selected token x at time t conditioned on the selection of tokens x₀ through xₜ₋₁.

The target model takes the generated n tokens and processes the n tokens to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens.

The target model can then verify the tokens generated by the draft model by comparing distributions from the draft model and target model to determine whether a token is accepted or rejected. A given token xₜ₊ₖ^{draft} may be accepted when ƒ(pₖ^{draft},pₖ^{target})<α, for some function ƒ and some threshold a (also known as an acceptance rate). Otherwise, the token may be rejected. The final token in a generated sequence of n tokens may then be generated at the first rejection position or at the last position n based on some function g(pₖ^{draft},pₖ^{target}).

Speculative decoding, with an acceptance rate of α, may result in cost reductions relative to using a single autoregressive model to generate tokens iteratively. Inference cost savings, relative to iterative token generation, may be represented by the expression:

$${C}^{AR} = {NC}^{target} \to {C}^{SD} = {nNC}^{draft} + \frac{N}{α + 1} {C}^{target}$$

where N corresponds to a number of tokens, C^{AR} corresponds to a computational cost using an acceptance rate of α, C^{target} corresponds to a computational cost of generating a sequence of tokens using the target model, C^{draft} corresponds to a computational cost of generating a sequence of tokens using the draft model, and n corresponds to a number of tokens generated speculatively via a single pass through an autoregressive model. Consider an example where N=1000, C^{target}=10, C^{draft}=1, n=4, and α=3. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating a response to an input query using per-token speculative decoding techniques may involve executing the draft model and target model for each token generated as part of a response to the input query, which may use significant amounts of computational resources (e.g., processor time, memory, memory bandwidth, etc.) in order to generate the response.

### Example Generating Responses to Queries Based on Guidance Signals in Generative Artificial Intelligence Models

Generally, inferencing using generative artificial intelligence models has a significant computational expense (e.g., a low rate at which tokens are generated, relative to the computational expense of generating these tokens) due to the autoregressive nature in which tokens are generated in response to an input query. While speculative decoding techniques, such as those discussed above, may allow for some increases in the rate at which tokens are generated, various scenarios exist in which a response generated by a generative artificial intelligence model is sufficiently accurate such that the performance of minor modifications may result in a semantically correct output sequence. Further, in some cases, open-ended tasks, such as dialog generation, translation, summarization of an input, or the like, may be performed in a manner such that the probability distribution for a response generated by the draft model need not exactly match the probability distribution for a response generated by the target model. Additionally, inferencing using generative artificial intelligence models has a significant computational expense that increases as the size of the output increases.

To improve the computational efficiency of generating responses to input queries using generative artificial intelligence models, aspects of the present disclosure provide techniques for generating responses to input queries based on guidance signals generated by a target model. As discussed in further detail herein, in some aspects, a draft model may generate a candidate response (including a sequence of n tokens) to an input query and provide the input query and the candidate response to the target model for processing. In turn, the target model can verify the candidate response by verifying the correctness of each token included in the candidate response. For tokens that are identified as incorrect, the target model can generate a guidance signal that corrects the candidate response or provides guidance (or other information) that the draft model can use to correct response. In some aspects, the guidance signal may include a plurality of tokens that replace the incorrect tokens identified in the candidate response or are used by the draft model to replace the incorrect tokens identified in the candidate response, and these replacement tokens may be generated by the target model itself or may be retrieved by the target model from one or more external sources. A generated response based on the candidate response and the guidance signals may be provided to the draft model, and the draft model may generate a refined response based on the candidate response and the guidance signals.

In some aspects, to improve the computational efficiency of generating responses to input queries using generative artificial intelligence models, aspects of the present disclosure provide techniques for generating guidance signals that a draft model can use in generating a response to an input query. As discussed in further detail herein, an input query received at a draft model may be provided to a target model, which is trained to generate a set of tasks that the draft model can perform to generate the response. The target model sends the draft model the set of tasks generated based on the input query, and the draft model can use the set of tasks to generate a response to the input query.

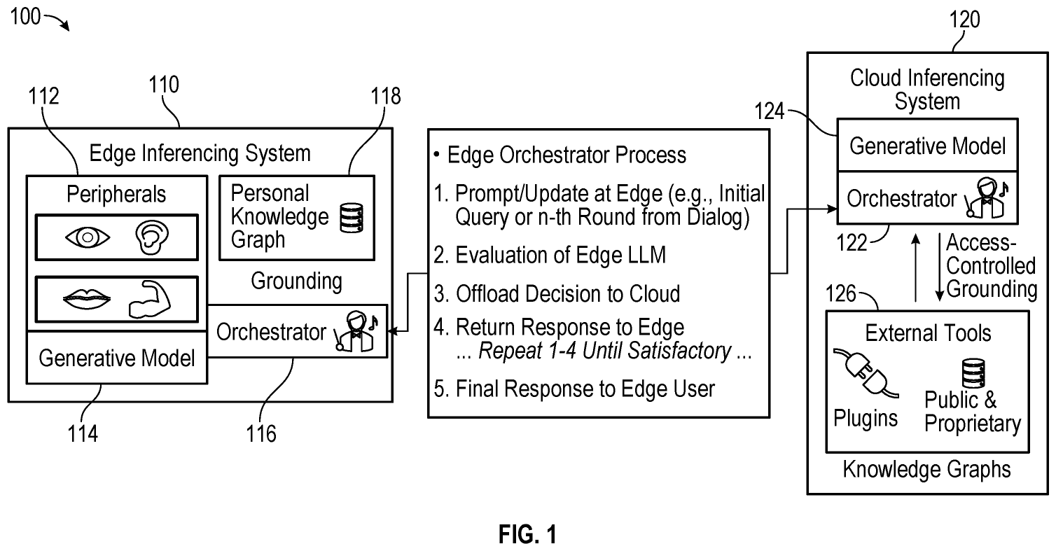

FIG. 1 illustrates an example computing environment 100 in which queries are iteratively processed using different devices within the computing environment, according to aspects of the present disclosure.

As illustrated, the computing environment 100 includes an edge inferencing system 110 and a cloud inferencing system 120. The edge inferencing system 110 may correspond to a computing device (e.g., a desktop computer, a laptop computer, a tablet computer, a smartphone, a wearable device, a vehicle, etc.) on which a generative artificial intelligence model, such as a large language model (LLM) trained to generate textual responses to a textual query, is deployed. The cloud inferencing system 120 may correspond to a generally available computing system, hosted in a cloud computing environment (e.g., one or more servers), that exposes a generative artificial model to the general public. Generally, the edge inferencing system 110 may correspond to devices having the most restricted computing capabilities (e.g., processing speed, memory capacity, memory bandwidth, etc.) within the computing environment 100, and the cloud inferencing system 120 generally has significantly more extensive computing capabilities than the edge inferencing system 110.

The edge inferencing system 110 generally includes one or more peripheral devices 112, a generative artificial intelligence model 114, an orchestrator 116, and a personal knowledge repository 118 (also referred to as a personal knowledge graph) that can be used to augment responses generated by the generative artificial intelligence model 114 (as discussed in further detail herein).

The one or more peripheral devices 112 generally allow for the edge inferencing system 110 to ingest a query (e.g., text input) and contextual information related to the ingested query. The peripheral devices 112 included in or connected to (e.g., communicatively coupled with) the edge inferencing system 110 can include audio-visual capture devices that can capture audio-visual data, sensors that can capture movement data, and/or other devices that can provide contextual information related to usage of the edge inferencing system 110. Generally, the edge inferencing system 110 can transform the input data captured by the one or more peripheral devices 112 into at least a query that can be input into a generative artificial intelligence model (e.g., the generative artificial intelligence model 114 at the edge inferencing system 110 and/or the generative artificial intelligence model 124 at the cloud inferencing system 120) in order to generate a response to the input query.

The orchestrator 116 generally orchestrates the generation of responses to input queries within the computing environment 100. Generally, the orchestrator may 116 may serve as an interface through which input queries and/or candidate responses generated by the generative artificial intelligence model 114 are output to a generative artificial intelligence model 124 at the cloud inferencing system 120 for verification and/or other processing (e.g., the generation of guidance signals or other information which the generative artificial intelligence model 114 can use for generating a candidate response or editing a previously generated candidate response) and through which these guidance signals may be received from the generative artificial intelligence model 124. More generally, the orchestrator 116 can offload to the cloud inferencing system 120 queries for processing or can offload the verification of responses generated to such queries to the cloud inferencing system 120.

In some aspects, the orchestrator 116 can maintain a count related to a number of rounds of revisions to a candidate response that have been performed by the generative artificial intelligence model 114 at the edge inferencing system 110 and/or the generative artificial intelligence model 124 deployed on the cloud inferencing system. When the count reaches a threshold level, the orchestrator 116 can determine that no further rounds of verification and revision are to be performed by the generative artificial intelligence model 124 and can instruct the generative artificial intelligence model 114 to perform some action, for example, to output the last generated candidate response as the response to the input query received at the edge inferencing system 110.

In some aspects, the orchestrator 116 can aid the generative artificial intelligence model 114 in the generation of a response to a received query by orchestrating the retrieval of information from one or more external resources, such as the personal knowledge repository 118, external tools 126 (discussed in further detail herein), and/or the like. In some aspects, the personal knowledge repository 118 generally includes user-specific knowledge that may be used to augment a response generated by the generative artificial intelligence model 114 to a query or to augment a query for initial processing by the generative artificial intelligence model 124 deployed on the cloud inferencing system 120. The knowledge or other information contained in the personal knowledge repository 118 may thus be used to personalize a response to a received query by allowing for user-specific (or profile-specific) information to be included in a response or provided as contextual information to the generative artificial intelligence model 114 and/or the generative artificial intelligence model 124 (amongst others) for those models to use in generating a response to an input query.

The cloud inferencing system 120, as illustrated, includes a generative artificial intelligence model 124, an orchestrator 122, and one or more external tools 126 (e.g., plugins, knowledge graphs, etc.). The orchestrator 122 may receive requests to process input queries from the edge inferencing system 110. The external tools 126 can be used (as discussed in further detail herein) to augment responses generated by the generative artificial intelligence model 124 deployed on the cloud inferencing system 120 and/or responses generated by other generative artificial intelligence models in the computing environment 100 (e.g., the generative artificial intelligence model 114 at the edge inferencing system 110 and/or other generative artificial intelligence models on other devices, not illustrated, in the computing environment 100). Generally, the generative artificial intelligence model 124 deployed on the cloud inferencing system 120 may be larger than the generative artificial intelligence model 114 deployed on the edge inferencing system 110 and other generative artificial intelligence models deployed on other devices in the computing environment 100. The generative artificial intelligence model 124 deployed on the cloud inferencing system 120 can be used to verify responses generated by the generative artificial intelligence model 114 deployed on the edge inferencing system 110 and/or to generate responses to queries offloaded from the edge inferencing system.

As used herein, the generative artificial intelligence model 114 illustrated in FIG. 1 as deployed on the edge inferencing system 110 may also be referred to as a “draft model” or “DM” (or “first generative artificial intelligence model”), and the generative artificial intelligence model 124 illustrated in FIG. 1 as deployed on the cloud inferencing system 120 may also be referred to as a “target model” or “TM” (or “second generative artificial intelligence model”). While the computing environment 100 illustrates the deployment of a draft model 114 on the edge inferencing system 110 and a target model 124 on the cloud inferencing system 120, it should be recognized that the draft model 114 and the target model 124 may be deployed on any combination of systems in the computing environment 100. For example, the draft model 114 and target model 124 may both be deployed on the edge inferencing system 110 or on the cloud inferencing system 120. In other examples, the draft model 114 may be deployed on the edge inferencing system 110, while the target model 124 may be deployed on another system (not illustrated) in the computing environment 100, such as an in-home server or an enterprise server. In yet other examples, the target model 124 may be deployed in a “split” deployment in which a portion of the target model 124 is deployed on another system (not illustrated) in the computing environment 100, such as an in-home server or an enterprise server, while the other portion of the target model 124 is deployed on the cloud inferencing system 120.

Generally, the use of a draft model 114 and a target model 124 may allow for the draft model 114 to be used in generating responses to input queries while allowing the draft model 114 to diverge from the target model 124. For example, the draft model 114 may not have access to the same data retrieval techniques as the target model 124, and thus, the use of the target model 124 may allow for the target model 124 to correct a response generated by the draft model 114 using additional data retrieval techniques, such as retrieval from the external tools 126 (e.g., sources external to the draft model 114 and the target model 124). Further, in some cases, the draft model 114 and the target model 124 may diverge in that an older version of the draft model 114 may be deployed on an edge inferencing system 110 while a newer version of the corresponding target model 124 may be deployed on a cloud inferencing system 120. In such a case, the updated target model 124 may be used to provide feedback to the draft model 114 to further improve the accuracy of the responses to input queries generated by the draft model 114 while allowing for resources to be saved by not updating the draft model 114 at the edge inferencing system 110.

The target model 124 may be trained to generate contextually correct tokens for a generated response using supervised training techniques. Generally, a training data set used in training the target model 124 may include a plurality of examples in which a corrupted version of a natural language sequence is mapped to a ground-truth version of the natural language sequence. The ground-truth version of the natural language sequence may be retrieved from one or more external sources, such as electronic databases or the like. Each example may be generated by randomly editing a ground-truth version of a natural language sequence. These edits may include random deletions of words from the natural language sequence, replacement of words with misspelled or nonsensical words, replacement of words or sequences of words with randomly generated characters, or the like. The target model 124 may be trained using this training data set to recognize the context around an input sequence (which may include nonsensical or incorrect tokens or be missing tokens) and generate guidance signals that may, for example, identify the correct words or tokens to be included in a valid response to an input query. As discussed in further detail below, these guidance signals may be integrated into a candidate response such that the target model 124 returns a corrected response to the draft model 114.

In some aspects, the target model 124 may be trained to generate guidance signals that aid the draft model 114 in generating a response. These guidance signals may include, for example, information identifying the proper context around a response (and thus the correct context for an answer generated by the draft model 114), instructions usable by the draft model 114 to generate a response, or the like. The target model 124 may be trained, for example, to generate a list of actions defined as a list of natural language commands or structured commands. In some aspects, these guidance signals may include signals or other information identifying portions of a candidate response which do not comply with external rules defined for a particular scenario, such as safety or regulatory rules defined for a particular topic or category of data included in a candidate response. These guidance signals may further include information identifying changes to the candidate response which may be used by the draft model 114 to generate a response that complies with these external rules.

In some aspects, where the target model 124 is used to verify and correct a candidate response generated by the draft model 114, the target model 124 can verify the probabilities of each token included in the candidate response using various autoregressive or non-autoregressive techniques. In some aspects, the target model 124 may be configured to define a correct candidate response as a response generated by the draft model 114 having a probability distribution matching the probability distribution of a response generated by the target model 124. In some aspects, however, the target model 124 may be trained to recognize a semantically similar answer generated by the draft model 114 as a sufficiently accurate response that can be output as a response to the input query.

The target model 124 can, in some aspects, determine that a token in a candidate response is incorrect and generate information identifying the next correct token in the candidate response. For the sequence of tokens that are identified as incorrect, the target model can then perform various actions to correct, or aid the draft model 114 in correcting, the candidate answer, using one or more guidance signals generated by the target model 124. For example, the target model 124 can generate a sequence of tokens that are to be used as direct replacements for the sequence of tokens identified as incorrect. In other examples, the target model 124 may have external information retrieval capabilities and can retrieve or generate a sequence of tokens from the external tools 126 (e.g., electronic databases, electronic document repositories, etc.) and generate a guidance signal including (or otherwise indicating) the tokens (and/or data) retrieved or otherwise generated from these external data sources.

As discussed, in some aspects, a guidance signal generated by the target model 124 may include contextual information which the draft model 114 can use to update the candidate response generated by the draft model 114. The contextual information may, for example, include specially defined tokens that are recognizable by the draft model 114 as instructions that are to be performed in updating specific portions of the candidate response. These instructions may be natural language instructions or structured grammar or commands which the draft model 114 can use in regenerating a candidate response or updating the candidate response.

Generally, the draft model 114 and target model 124 may iterate through various revisions of a candidate response by repeating the techniques discussed above for each version of a candidate response. After the target model 124 determines that a candidate response generated and revised by the draft model 114 is semantically acceptable (e.g., has a probability distribution and semantic meaning that is sufficiently close to the probability distribution and semantic meaning of a response that would be generated by the target model 124), the draft model 114 and/or target model 124 can output the candidate response as the response to the input query. In some aspects, the target model 124 can output, to the draft model 114, a signal indicating that the candidate response is an acceptable response, and the draft model 114 can use this signal to output the candidate response and terminate any further revision iterations to the candidate response. In some aspects, the target model 124 can directly output the candidate response as the final response to the input query.

In some aspects, the target model 124 may be used to generate a set of actions that the draft model 114 is to execute in order to generate a response to an input query or revise a candidate answer to an input query. For example, when an input query is received, the draft model 114 can provide the input query to the target model 124 directly and can wait until the target model 124 returns the set of actions or other guidance signals before processing the input query. After the target model 124 generates the set of actions or other guidance signals and provides information identifying the set of actions to the draft model 114, the draft model 114 can generate a candidate response by executing the set of actions (e.g., sequentially, in parallel, or in some combination of sequentially and in parallel) based on information included in the set of actions). The candidate response may, in some aspects, be provided to the target model 124 for verification and iterative refinement, as discussed above, until the target model 124 determines that the candidate response is a sufficiently accurate and responsive response to the input query.

By using a target model (e.g., the generative artificial intelligence model 124) to provide guidance signals usable by the draft model (e.g., the generative artificial intelligence model 114) in generating a response to an input query, aspects of the present disclosure may allow for the draft model to perform a significant amount of the work involved in generating responses to input queries. Generally, as the length N(0) of a sequence of tokens (corresponding to a candidate response) generated by the draft model increases, the number of iterations through the target model may correspond to a small fraction of N(0). By doing so, the token generation rate may be significantly increased, thus improving the efficiency of generative artificial intelligence models.

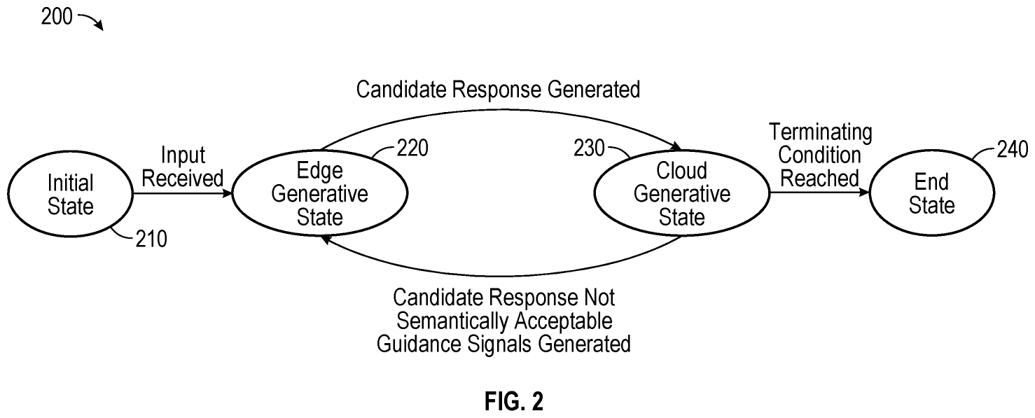

FIG. 2 is a state diagram 200 illustrating operations for generating a corrected response to an input query using generative artificial intelligence models, according to aspects of the present disclosure.

As illustrated, in the state diagram 200, generating a corrected response to the input query using generative artificial intelligence models may begin at the initial state 210, in which an edge inferencing system (e.g., the generative artificial intelligence model 114 illustrated in FIG. 1 and described above) waits to receive an input query for processing, and the edge inferencing system may exit this initial state with receiving an input query X for which an output is to be generated. At an edge generative state 220, a draft model (e.g., 114), which may be deployed on the edge inferencing system, may generate an initial candidate response including a plurality of tokens, where each token corresponds to a word, a portion of a word, or set of words in the response. After generating the initial candidate response, the operations illustrated in the state diagram 200 can proceed to a cloud generative state 230, where the draft model provides the initial candidate response to a target model (e.g., the generative artificial intelligence model 124 illustrated in FIG. 1 and described above) for verification.

The target model may be deployed on the edge inferencing system, a cloud inferencing system (e.g., 120), or any combination thereof, as discussed above. Generally, the target model can verify the initial candidate response on a per-token basis and generate guidance signals that can be used by one or both of the draft model or the target model to generate a semantically correct, or at least semantically acceptable, response to the input query X. As discussed, in some aspects, the guidance signals may include (but are not limited to) edits to specific tokens in a candidate response, contextual information related to specific tokens in the candidate response to indicate to the draft model that specific tokens are to be replaced, and/or instructions identifying specific actions to be performed with respect to specific tokens in the candidate response. The target model may generate these guidance signals autoregressively (e.g., in the same manner in which the draft model generated the candidate response) and/or may generate these guidance signals by referencing one or more external sources, such as electronic databases, electronic document repositories, or the like. In some aspects, where the guidance signals include edits to specific tokens in a candidate response, the target model can directly edit the candidate response.

If the target model determines that the candidate response is not semantically acceptable at the cloud generative state 230, the operations illustrated in the state diagram 200 may return to the edge generative state 220. In doing so, the target model can output a response to the draft model based on the candidate response and the generated guidance signals. While in the edge generative state 220, the draft model can execute various token generation operations based on the candidate response and the generated guidance signals to generate a new candidate response. The operations illustrated in the state diagram 200 may return to the cloud generative state 230, in which the new candidate response is provided back to the target model for verification, as discussed above.

If, while in the cloud generative state 230, the target model determines that the candidate response is semantically acceptable relative to a response that would be generated by the target model, the operations illustrated in the state diagram 200 may proceed to the end state 240. In the end state 240, the target model may output the candidate response as the response to the input query X. After outputting the candidate response as the response to the input query X, the operations illustrated in the state diagram 200 may terminate with respect to the input query X.

In some aspects, various terminating conditions may be defined for determining when to output a response generated by a generative artificial intelligence model 114 at the edge inferencing system 110 and verified by generative artificial intelligence model 124 at the cloud inferencing system 120 even when the candidate response generated by the generative artificial intelligence model 114 is not semantically acceptable. For example, these terminating conditions may include a maximum number of iterations of verifying a response to an input query generated by the draft model. If the maximum number of iterations have been executed, the operations illustrated in the state diagram 200 may proceed to the end state 240. At the end state 240, the target model may perform some predetermined action, such as outputting the most recently generated response as a response to the input query X. As such, in some aspects, this may result in foregoing further refinement of the candidate response. Another example may include the passage of time (e.g., if a threshold X amount of time has passed, the operations illustrated in the state diagram 200 may proceed to the end state 240).

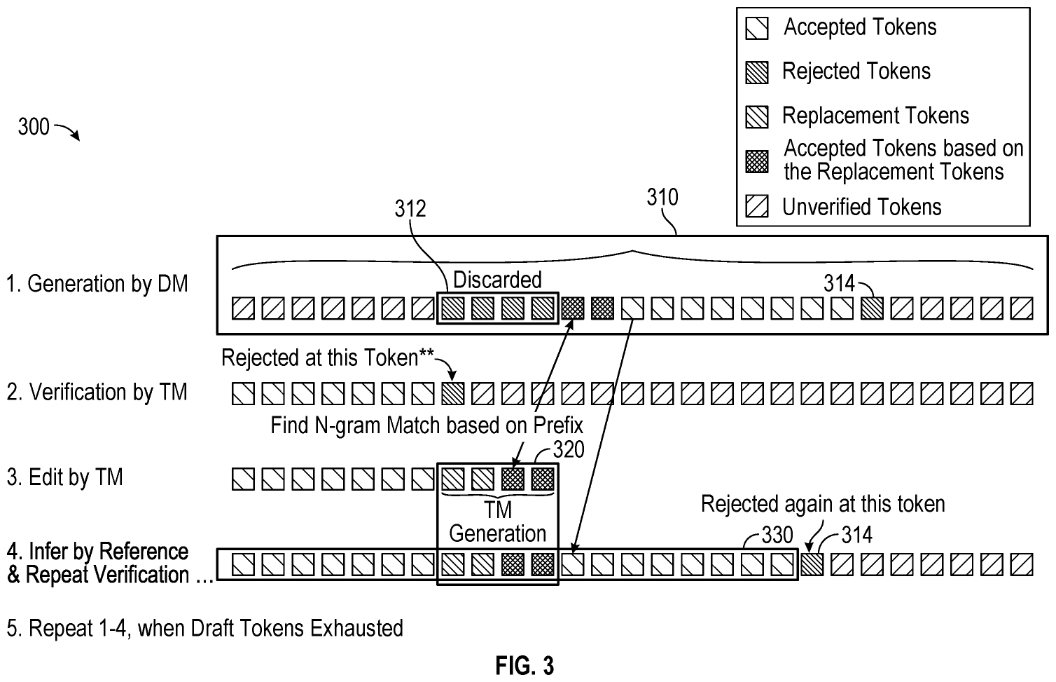

FIG. 3 illustrates an example 300 of generating corrective guidance signals for a draft response to an input query, according to aspects of the present disclosure.

As illustrated, in the example 300, a draft model (e.g., the generative artificial intelligence model 114 on the edge inferencing system 110 illustrated in FIG. 1) can initially generate a sequence of tokens 310 in response to an input query X received for processing. In some aspects, the sequence of tokens 310 may be generated up to a defined length. As discussed, the draft model can generate the sequence of tokens autonomously or based on a set of instructions generated by a target model (e.g., the generative artificial intelligence model 124 of FIG. 1) for the given input query X.

After generating the initial sequence of tokens 310, the draft model provides the initial sequence of tokens 310 to the target model for verification. When the target model rejects a token (e.g., a set of rejected tokens 312 and/or a rejected token 314), the target model can identify the location of the rejected token(s) 312, 314 (some of which may be rejected in a later round of verification using the techniques discussed herein with respect to the rejected tokens 312) and generate one or more guidance signals that can be used by the draft model to replace the rejected token(s) 312, 314.

For example, as illustrated, the target model can generate a replacement sequence of tokens 320 to replace the rejected tokens and can, in some aspects, directly replace the rejected tokens 312 with the generated replacement sequence of tokens 320. It should be recognized, however, that in some aspects, the target model can generate the replacement tokens and provide the replacement tokens to the draft model for the draft model to use in replacing an identified set of rejected tokens prior to generating another candidate response to the input query. In some aspects, the target model can retrieve tokens or other information for the replacement sequence of tokens 320 from one or more external sources, such as a vector data store including previously retrieved data from one or more external sources or data directly retrieved from one or more external sources via tools allowing the target model direct access to these external sources. By retrieving tokens from these external sources, aspects of the present disclosure may reduce the computational expense of generating a response to an input query using generative artificial intelligence models, as retrieval from an external source may use significantly fewer processing cycles than generating tokens using a generative artificial intelligence model.

The target model can, in some aspects, generate a revised sequence of tokens 330. In particular, the rejected token(s) 312 in the initial sequence of tokens 310 may be replaced with the replacement sequence of tokens 320. Subsequently, the target model can continue verifying the revised sequence of tokens, starting with the next token generated by the draft model (e.g., not including the tokens generated by the target model). The process described above may be repeated as tokens are verified or rejected, until no further tokens generated by the draft model are available for verification.

In some aspects, the identification of rejected token 312, 314 (and thus locations at which tokens are to be replaced) and the replacement of these rejected tokens may be performed in a multi-stage operation. During a first stage of the multi-stage operation, the target model can identify which tokens are to be rejected as tokens which have probabilistic mismatches relative to the probability distribution at the target model. At a second stage of the multi-stage operation, the target model can identify and/or otherwise generate replacement sets of tokens (e.g., the replacement sequence of tokens 320 illustrated in FIG. 3) for the rejected tokens 312, 314 in the sequence of tokens 310 corresponding to the candidate response generated by the draft model and provided to the target model for verification.

In some aspects, the target model can determine an initial edit location (e.g., the location of a first rejected token in a sequence of tokens, such as the sequence of tokens 312) in a candidate response generated by a draft model based on a comparison of target token conditional probabilities to draft token conditional probabilities.

In some aspects, the draft model can determine whether to use the target model to verify a candidate response based on a scoring model, which may be implemented by a neural network or other machine learning model. The scoring model can generally account for the conditional token probabilities associated with each of the tokens included in the candidate response. If the conditional token probabilities, in aggregate, exceed a threshold value, or if the conditional token probabilities for each token exceeds a threshold value, the draft model can determine that the generated candidate response is likely to be accurate and can thus bypass verification by the target model. By doing so, aspects of the present disclosure can further reduce the amount of computational resources used in generating a response to an input query using generative artificial intelligence models.

In some aspects, the draft model may be an autoregressive generative artificial intelligence model in which predictions of tokens or other outputs of the generative artificial intelligence model are based on tokens previously generated by the autoregressive generative artificial intelligence model. The target model may, in some aspects, also be an autoregressive generative artificial intelligence model. However, in some aspects, the target model may be a non-autoregressive artificial intelligence model that refines the output of the draft model. In some aspects, the draft model and the target model may be transformer-based artificial intelligence models in which an output value is generated based on an attention mechanism and a set of key data and query data as an input.

### Example Operations for Generating Responses to Queries Based on Guidance Signals in Generative Artificial Intelligence Models

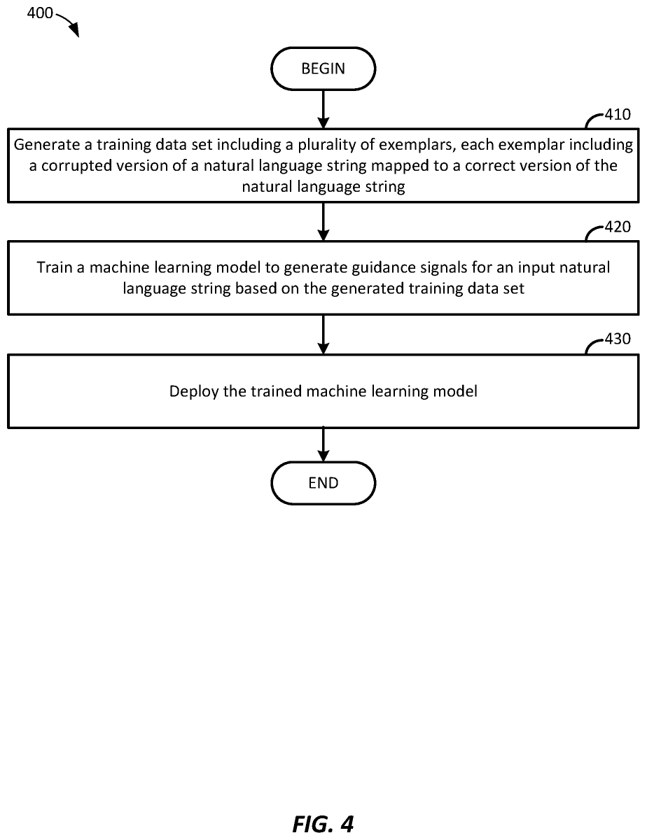

FIG. 4 illustrates example operations 400 for training a generative artificial intelligence model to generate corrective signals for a draft response to an input query (e.g., as illustrated in FIGS. 2 and 3), according to aspects of the present disclosure. The operations 400 may be performed, for example, by a computing system such as a server computer, a cluster of compute devices, or the like (e.g., an edge inferencing system 110 or a cloud inferencing system 120 illustrated in FIG. 1).

As illustrated, the operations 400 begin at block 410, with generating (or otherwise acquiring) a training data set including a plurality of exemplars. Each exemplar generally includes a corrupted version of a natural language string mapped to a correct version of the natural language string. The correct version of the natural language string may be sourced from various external sources, such as electronic databases, publications, or other sources from which natural language content may be retrieved.

To generate the corrupted version of a natural language string, various editing techniques may be used. For example, random numbers of words may be removed from a correct version of the natural language string, and words may be removed at random places in the natural language string. In other examples, random character-level edits may be performed on the correct version of the natural language string (e.g., to introduce typographical errors into various words in a natural language string). In still further examples, words in a natural language string may be replaced with random words from a dictionary or random sequences of characters. It should be recognized, however, that the foregoing are but examples of corruptions that can be performed on a natural language string, and other techniques for generating corrupted versions of natural language strings may be contemplated.

At block 420, the operations 400 proceed with training a machine learning model to generate guidance signals for an input natural language string based on the generated training data set. The machine learning model may be trained using supervised learning techniques so that the machine learning model is trained based on the mappings between corrupted versions of natural language strings to the correct versions of those natural language strings discussed above. In some aspects, the guidance signals may be directly used by the machine learning model to edit a candidate response generated by a draft model or other generative artificial intelligence model. For example, these guidance signals may identify a location at which tokens in a candidate response are to be replaced and the replacement sequence of tokens to use in replacing rejected tokens. In some aspects, the guidance signals may include various contextual clues which a draft model can use in generating a candidate response to an input query. As discussed above, these guidance signals may be generated before a draft model generates a candidate response to an input query, such that the draft model can use these guidance signals in generating the initial candidate response to the input query. In other examples, these guidance signals may be generated while the machine learning model is verifying a candidate response generated by the draft model.

At block 430, the operations 400 proceed with deploying the trained machine learning model. The trained machine learning model may be deployed as a target model executing on a cloud inferencing system, an edge inferencing system, or other device on which a machine learning model can be deployed.

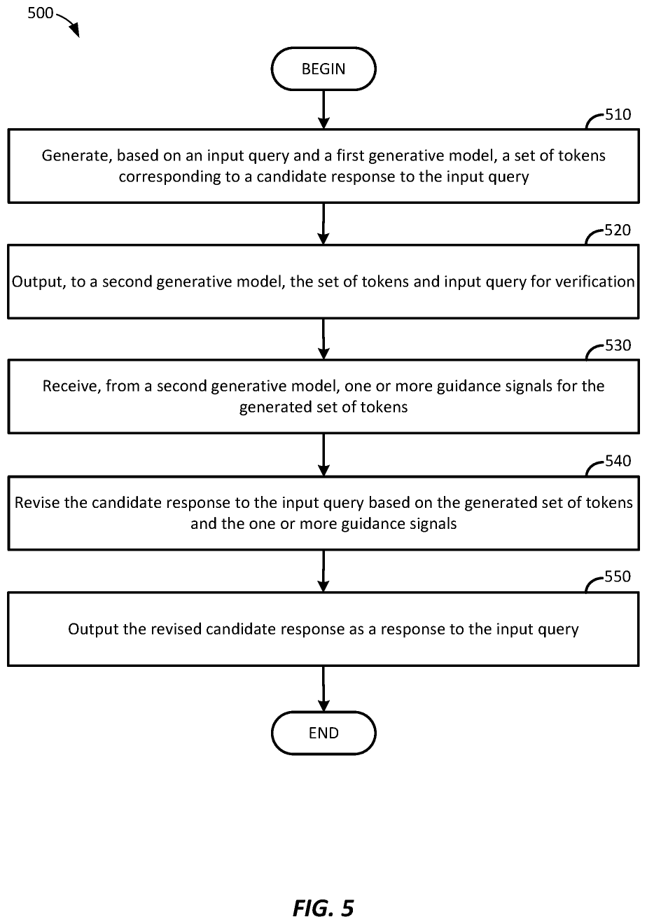

FIG. 5 illustrates example operations 500 for generating a response to an input query using generative artificial intelligence models, according to aspects of the present disclosure. The operations 500 may be performed, for example, by an edge inferencing system, such as the edge inferencing system 110 illustrated in FIG. 1, or other computing device on which a draft model can execute to generate a candidate response to an input query.

As illustrated, the operations 500 begin at block 510, with generating, based on an input query and a first generative artificial intelligence model (e.g., draft model 114 in FIG. 1), a sequence of tokens corresponding to a candidate response to the input query.

At block 520, the operations 500 proceed with outputting, to a second generative artificial intelligence model (e.g., target model 124 in FIG. 1), the sequence of tokens and the input query for verification.

At block 530, the operations 500 proceed with receiving, from the second generative artificial intelligence model, one or more first guidance signals for the generated sequence of tokens.

At block 540, the operations 500 proceed with revising the candidate response to the input query based on the generated sequence of tokens and the one or more first guidance signals.

In some aspects, revising the candidate response to the input query may include determining that a threshold number of revisions have been performed with respect to a response generated by the first generative artificial intelligence model to the input query. In such a case, the candidate response may be output as the revised response to the input query, as it may be assumed that further rounds of revising a candidate response generated by the first generative artificial intelligence model may not result in the generation of a response that has a sufficient increase in accuracy for the computational resources that would be expended through further verification rounds performed by the second generative artificial intelligence model.

At block 550, the operations 500 proceed with outputting a response to the input query based on the generated sequence of tokens and the one or more first guidance signals.

In some aspects, the sequence of tokens corresponding to the candidate response to the input query may be generated based on one or more guidance signals generated by a second generative artificial intelligence model. In some examples, the second generative artificial intelligence model may receive the input query, generate a set of instructions based on the received input query, and output the generated set of instructions to the first generative artificial intelligence model. In turn, the first generative artificial intelligence model may use the generated set of instructions generated by the second generative artificial intelligence model to generate the candidate response. The set of instructions may be a set of natural language instructions or a set of structured commands executable by the first generative artificial intelligence model.

In some aspects, the one or more first guidance signals may identify a token location(s) within the candidate response at which the incorrect token(s) is to be replaced. In some aspects may identify a number of consecutive incorrect tokens to be replaced from the identified location. To revise the candidate response, a second candidate response may be generated based on the generated sequence of tokens, with the identified incorrect token(s) being replaced by one or more replacement tokens. The one or more replacement tokens may be tokens generated by the first generative artificial intelligence model based on the second generative artificial intelligence model's rejection of the identified incorrect tokens. In some aspects, the one or more replacement tokens may be included in the one or more first guidance signals. In such a case, these replacement tokens may be generated by the second generative artificial intelligence model autoregressively (e.g., by generating a response to the input query independently from the response generated by the first generative artificial intelligence model) or may be generated by retrieving information from one or more external sources, such as personal knowledge repositories associated with the user of the device on which the first generative artificial intelligence model is deployed, public knowledge repositories, or the like. The tokens corresponding to the second candidate response may be output to the second generative artificial intelligence model for verification, and one or more second guidance signals may be received for the tokens corresponding to the second candidate response. The second guidance signals, like the first guidance signals generated for the candidate response, may similarly identify a token location within the candidate response at which an incorrect token is to be replaced and a number of consecutive incorrect tokens to be replaced from the identified location.

In some aspects, the one or more first guidance signals may include signals usable by the first generative artificial intelligence model to generate the revised response. For example, the one or more first guidance signals may include information identifying locations of rejected tokens in the candidate response and contextual information or instructions which the first generative artificial intelligence model can use in generating a revised candidate response to the input query. These signals may include, for example, one or more structured grammar commands instructing the first generative artificial intelligence model to generate the revised candidate response according to one or more defined rules, a natural language command instructing the first generative artificial intelligence model to generate the revised response according to one or more defined rules, or the like.

In some aspects, revising the candidate response to the input query may include generating a second candidate response based on the generated sequence of tokens and the one or more first guidance signals. Tokens corresponding to the second candidate response may be output to the second generative artificial intelligence model for verification, and one or more second guidance signals may be received for the tokens corresponding to the second candidate response. In some aspects, the one or more second guidance signals may indicate that the second candidate response is a semantically acceptable response to the input query. Generally, a semantically acceptable response may be a response that has a probability distribution and semantic meaning that is sufficiently close to the probability distribution and semantic meaning of a response that would be generated by the second generative artificial intelligence model. In such a case, no further revisions need be performed with respect to the second candidate response, and the second candidate response may be output as the response to the received input query.

In some aspects, the operations 500 may further include outputting, to the second generative artificial intelligence model, the input query. The input query may be output to the second generative artificial intelligence model for processing prior to the first generative artificial intelligence model generating a candidate response to the input query. The first generative artificial intelligence model may receive information identifying a list of actions to be performed by the first generative artificial intelligence model to generate the candidate response to the input query, and the list of actions may be executed by the first generative artificial intelligence model in order to generate the candidate response. The list of actions may include (but is not limited to) a set of instructions executable by the first generative artificial intelligence model, a natural language list of actions which can be interpreted by the first generative artificial intelligence model, or the like.

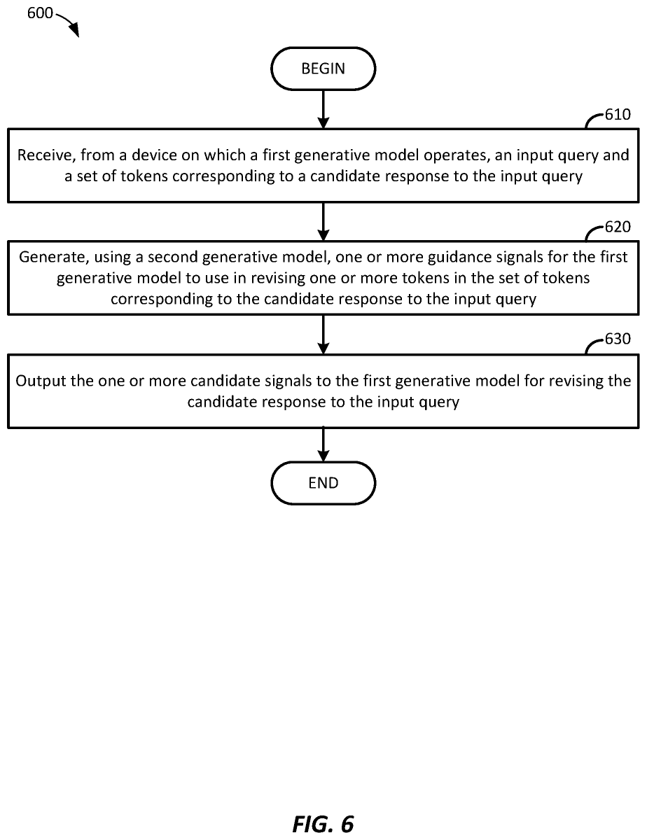

FIG. 6 illustrates example operations 600 for generating a corrected response to an input query using generative artificial intelligence models, according to aspects of the present disclosure. The operations 600 may be performed, for example, by a device, such as the cloud inferencing system 120 illustrated in FIG. 1, on which a target model executes to verify a response generated by a draft model.

As illustrated, the operations 600 begin at block 610, with receiving, from a system on which a first generative artificial intelligence model (e.g., the generative artificial intelligence model 114) executes, an input query and a sequence of tokens corresponding to a candidate response to the input query.

At block 620, the operations 600 proceed with generating, using a second generative artificial intelligence model (e.g., the generative artificial intelligence model 124), one or more guidance signals for the first generative artificial intelligence model to use in revising one or more tokens in the sequence of tokens corresponding to the candidate response to the input query.

In some aspects, generating the one or more guidance signals includes verifying tokens in the sequence of tokens corresponding to the candidate response in the input query. One or more token locations within the candidate response at which the incorrect token(s) is to be replaced are identified. In some aspects, a number of consecutive incorrect tokens to be replaced from the identified token locations are identified based on the verifying. In some aspects, verifying the tokens in the sequence of tokens may include generating a response to the input query using the second generative artificial intelligence model and comparing a probability distribution associated with tokens in the candidate response to the probability distribution associated with tokens in the response generated by the second generative artificial intelligence model. A mismatch between probability distributions that exceeds a threshold level may, in some aspects, be indicative of a divergence to be corrected between the candidate response and the response generated by the second generative artificial intelligence model.

In some aspects, the one or more guidance signals may further include one or more replacement tokens to be inserted into a candidate response to replace one or more incorrect tokens identified in the candidate response. The one or more replacement tokens may be tokens included (or otherwise indicated) in the one or more guidance signals. In such a case, these replacement tokens may be generated by the second generative artificial intelligence model autoregressively (e.g., by generating a response to the input query independently from the response generated by the first generative artificial intelligence model) or may be generated by retrieving information from one or more external sources, such as personal knowledge repositories (e.g., the personal knowledge repository 118) associated with the user of the device on which the first generative artificial intelligence model is deployed, public knowledge repositories, or the like.

In some aspects, the one or more guidance signals may include signals usable by the first generative artificial intelligence model to generate the revised response. For example, the one or more guidance signals may include information identifying locations of rejected tokens in the candidate response and contextual information or instructions which the first generative artificial intelligence model can use in generating a revised candidate response to the input query. These signals may include, for example, one or more structured grammar commands instructing the first generative artificial intelligence model to generate the revised candidate response according to one or more defined rules, a natural language command instructing the first generative artificial intelligence model to generate the revised response according to one or more defined rules, or the like.

In some aspects, generating the one or more guidance signals may include determining that the candidate response is a semantically acceptable response to the input query. As discussed above, a semantically acceptable response to the input query may be a response that has a probability distribution and semantic meaning that is sufficiently close to the probability distribution and semantic meaning of a response that would be generated by the second generative artificial intelligence model. In such a case, no further revisions need be performed with respect to the candidate response, and the one or more guidance signals may include an indication that the candidate response is a semantically acceptable response.

At block 630, the operations 600 proceed with outputting, to the first generative artificial intelligence model, the one or more guidance signals for revising the candidate response to the input query.

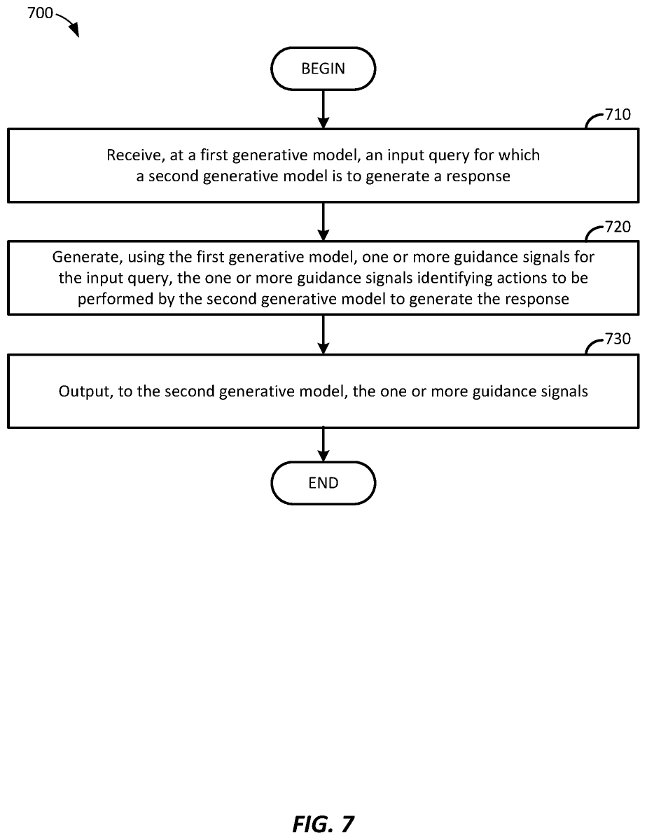

FIG. 7 illustrates example operations 700 for generating guidance signals for a generative artificial intelligence model to use in generating a response to an input query, according to aspects of the present disclosure. The operations 700 may be performed, for example, by a device (e.g., the cloud inferencing system 120 illustrated in FIG. 1) on which a target model executes to generate instructions usable by a draft model (e.g., executing on an edge inferencing system 110 illustrated in FIG. 1 or other computing device on which a draft model executes to generate a candidate response to the input query) in generating a response to an input query.

As illustrated, the operations 700 begin at block 710, with receiving, at a second generative artificial intelligence model (e.g., the generative artificial intelligence model (or target model) 124), an input query for which a first generative artificial intelligence model (e.g., the generative artificial intelligence model (or draft model) 114) is to generate a response.

At block 720, the operations 700 proceed with generating, using the second generative artificial intelligence model, one or more guidance signals for the input query. The one or more guidance signals generally identify actions to be performed by the second generative artificial intelligence model to generate the response. The guidance signals may include, for example, a set of instructions, formatted as a set of natural language instructions or a set of structured commands, executable by the first generative artificial intelligence model in order to generate a response to the input.

At block 730, the operations 700 proceed with outputting, to the first generative artificial intelligence model, the one or more guidance signals.

### Example System for Generating Responses to Queries Based on Guidance Signals in Generative Artificial Intelligence Models

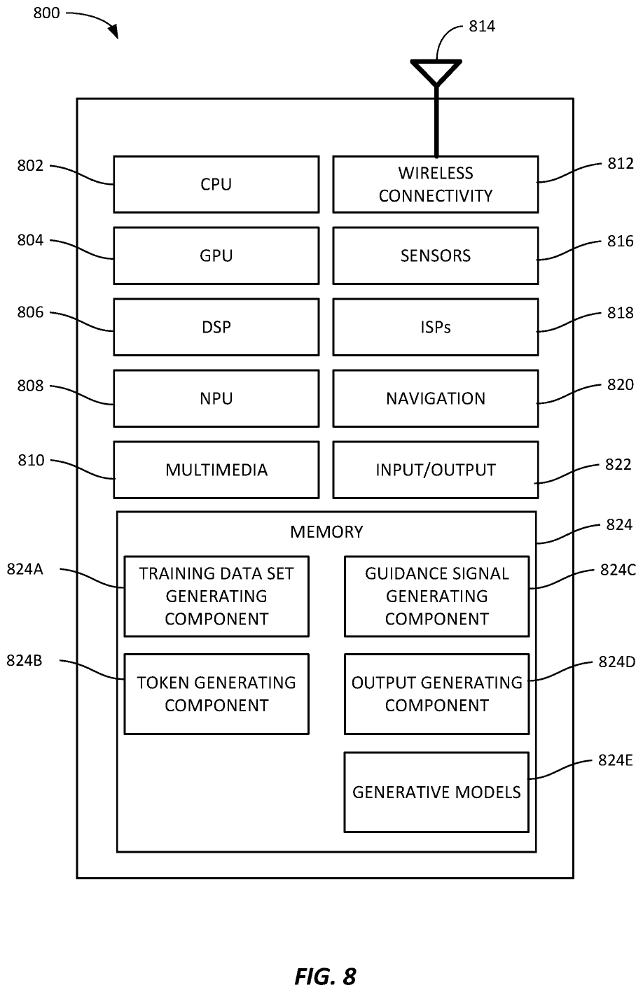

FIG. 8 depicts an example processing system 800 for generating a response to a query input into a generative artificial intelligence model based on group speculative decoding, such as described herein for example with respect to FIGS. 1-7.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., of memory 824).

The processing system 800 also includes additional processing components tailored to specific functions, such as a graphics processing unit (GPU) 804, a digital signal processor (DSP) 806, a neural processing unit (NPU) 808, and a connectivity component 812.

An NPU, such as the NPU 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 808 is a part of one or more of the CPU 802, the GPU 804, and/or the DSP 806. These may be located on a user equipment (UE) in a wireless communication system or another computing device.

In some examples, the connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 812 may be further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a training data set generating component 824A, a token generating component 824B, a guidance signal generating component 824C, an output generating component 824D, and generative artificial intelligence models 824E. The depicted components, and others not depicted, may be configured to perform various aspects of the methods described herein.

Generally, the processing system 800 and/or components thereof may be configured to perform the methods described herein.

### Example Clauses

Implementation details of various aspects of the present disclosure are described in the following numbered clauses:

Clause 1: A processor-implemented method, comprising: generating, based on an input query and a first generative artificial intelligence model, a sequence of tokens corresponding to a candidate response to the input query; outputting, to a second generative artificial intelligence model, the sequence of tokens and the input query for verification; receiving, from the second generative artificial intelligence model, one or more first guidance signals for the generated sequence of tokens; revising the candidate response to the input query based on the generated sequence of tokens and the one or more first guidance signals; and outputting the revised candidate response as a response to the input query.

Clause 2: The method of Clause 1, wherein the one or more first guidance signals identify a token location within the candidate response at which at least one incorrect token is to be replaced.

Clause 3: The method of Clause 2, wherein revising the candidate response to the input query comprises: generating a second candidate response based on the generated sequence of tokens and the one or more first guidance signals; outputting, to the second generative artificial intelligence model, tokens corresponding to the second candidate response; receiving one or more second guidance signals for the tokens corresponding to the second candidate response; and generating a third candidate response based on the tokens corresponding to the second candidate response and the one or more second guidance signals.

Clause 4: The method of Clause 3, wherein the second candidate response replaces the at least one incorrect token with replacement tokens included in the one or more first guidance signals.

Clause 5: The method of any of Clauses 2 through 4, wherein: the one or more second guidance signals indicate that the second candidate response is a semantically acceptable response to the input query; and outputting the revised candidate response as the response to the input query comprises outputting the second candidate response as the response to the input query.

Clause 6: The method of any of Clauses 1 through 5, wherein the one or more first guidance signals comprise one or more signal including instructions for the first generative artificial intelligence model to use in generating the revised candidate response.

Clause 7: The method of Clause 6, wherein the one or more signals comprise one or more structured grammar commands instructing the first generative artificial intelligence model to generate the revised candidate response according to one or more rules.

Clause 8: The method of Clauses 6 or 7, wherein the one or more signals comprise a natural language command instructing the first generative artificial intelligence model to generate the revised candidate response according to one or more rules.

Clause 9: The method of any of Clauses 1 through 8, wherein: revising the candidate response to the input query comprises determining that a threshold number of revisions have been performed with respect to a response generated by the first generative artificial intelligence model to the input query; and outputting the revised candidate response comprises outputting the candidate response as the response to the input query based on determining that the threshold number of revisions have been performed.

Clause 10: The method of any of Clauses 1 through 9, further comprising: outputting, to the second generative artificial intelligence model, the input query; and receiving, from the second generative artificial intelligence model, information identifying a list of actions to be performed by the first generative artificial intelligence model to generate the candidate response, wherein the candidate response is generated further based on the list of actions.

Clause 11: The method of any of Clauses 1 through 10, wherein the first model comprises a model executing on a local device, and wherein the second model comprises a model executing on a device remote from the local device.

Clause 12: A processor-implemented method, comprising: receiving, from a first generative artificial intelligence model operates, an input query and a sequence of tokens corresponding to a candidate response to the input query; generating, using a second generative artificial intelligence model, one or more guidance signals for the first generative artificial intelligence model to use in revising one or more tokens in the sequence of tokens corresponding to the candidate response to the input query; and outputting the one or more guidance signals to the first generative artificial intelligence model for revising the candidate response to the input query.

Clause 13: The method of Clause 12, wherein generating the one or more guidance signals comprises: verifying tokens in the sequence of tokens corresponding to the candidate response to the input query; and identifying a token location within the candidate response at which at least one incorrect token is to be replaced based on the verifying.

Clause 14: The method of Clause 13, wherein generating the one or more guidance signals further comprises generating a replacement sequence of tokens using the second generative artificial intelligence model for the at least one incorrect token identified within the candidate response.

Clause 15: The method of any of Clauses 12 through 14, wherein the one or more guidance signals comprise signals usable by the first generative artificial intelligence model to revise the candidate response.

Clause 16: The method of Clause 15, wherein the signals usable by the first generative artificial intelligence model to revise the candidate response comprise one or more structured grammar commands instructing the first generative artificial intelligence model to revise the candidate response according to one or more rules.

Clause 17: The method of Clauses 15 or 16, wherein the signals usable by the first generative artificial intelligence model to revise the candidate response comprise a natural language command instructing the first generative artificial intelligence model to revise the candidate response according to one or more rules.

Clause 18: The method of any of Clauses 12 through 17, wherein generating the one or more guidance signals comprises: determining that the candidate response is a semantically acceptable response to the input query; and generating an indication that the candidate response is semantically acceptable as the one or more guidance signals.

Clause 19: The method of any of Clauses 12 through 18, wherein the first model comprises a model executing on a local device, and wherein the second model comprises a model executing on a device remote from the local device.

Clause 20: A processing system comprising: a memory having executable instructions stored thereon; and one or more processors configured to execute the executable instructions to cause the processing system to perform the method of any of Clauses 1 through 19.

Clause 21: A processing system, comprising means for performing the method of any of Clauses 1 through 19.

Clause 22: A computer-readable medium having instructions stored thereon which, when executed by one or more processors, cause the one or more processors to perform the method of any of Clauses 1 through 19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
generate, based on an input query and a first generative artificial intelligence model, a sequence of tokens corresponding to a candidate response to the input query;
output, to a second generative artificial intelligence model, the sequence of tokens and the input query for verification;
receive, from the second generative artificial intelligence model, one or more first guidance signals for the generated sequence of tokens;
revise the candidate response to the input query based on the generated sequence of tokens and the one or more first guidance signals; and
output the revised candidate response as a response to the input query.

2. The processing system of claim 1, wherein the one or more first guidance signals identify a token location within the candidate response at which at least one incorrect token is to be replaced.

3. The processing system of claim 2, wherein to revise the candidate response to the input query, the one or more processors are configured to cause the processing system to:
generate a second candidate response based on the generated sequence of tokens and the one or more first guidance signals;
output, to the second generative artificial intelligence model, tokens corresponding to the second candidate response;
receive one or more second guidance signals for the tokens corresponding to the second candidate response; and
generate a third candidate response based on the tokens corresponding to the second candidate response and the one or more second guidance signals.

4. The processing system of claim 3, wherein the second candidate response replaces the at least one incorrect token with replacement tokens included in the one or more first guidance signals.

5. The processing system of claim 3, wherein:
the one or more second guidance signals indicate that the second candidate response is a semantically acceptable response to the input query; and
to output the revised candidate response as the response to the input query, the one or more processors are configured to cause the processing system to output the second candidate response as the response to the input query.

6. The processing system of claim 1, wherein the one or more first guidance signals comprise one or more signals including instructions for the first generative artificial intelligence model to use in generating the revised candidate response.

7. The processing system of claim 6, wherein the one or more signals comprise one or more structured grammar commands instructing the first generative artificial intelligence model to generate the revised candidate response according to one or more rules.

8. The processing system of claim 6, wherein the one or more signals comprise a natural language command instructing the first generative artificial intelligence model to generate the revised candidate response according to one or more rules.

9. The processing system of claim 1, wherein:
to revise the candidate response to the input query, the one or more processors are configured to cause the processing system to determine that a threshold number of revisions have been performed with respect to a response generated by the first generative artificial intelligence model to the input query; and
to output the revised candidate response, the one or more processors are configured to cause the processing system to output the candidate response as the response to the input query based on determining that the threshold number of revisions have been performed.

10. The processing system of claim 1, wherein the one or more processors are further configured to cause the processing system to:
output, to the second generative artificial intelligence model, the input query; and
receive, from the second generative artificial intelligence model, information identifying a list of actions to be performed by the first generative artificial intelligence model to generate the candidate response, wherein the candidate response is generated further based on the list of actions.

11. The processing system of claim 1, wherein the first model comprises a model hosted for execution on the processing system and wherein the second model comprises a model hosted for execution on a system remote from the processing system.

12. A processing system, comprising:
at least one memory having executable instructions stored thereon; and
one or more processors configured to execute the executable instructions to cause the processing system to:
receive, from a a first generative artificial intelligence model operates, an input query and a sequence of tokens corresponding to a candidate response to the input query;
generate, using a second generative artificial intelligence model, one or more guidance signals for the first generative artificial intelligence model to use in revising one or more tokens in the sequence of tokens corresponding to the candidate response to the input query; and
output the one or more guidance signals to the first generative artificial intelligence model for revising the candidate response to the input query.

13. The processing system of claim 12, wherein to generate the one or more guidance signals, the one or more processors are configured to cause the processing system to:
verify tokens in the sequence of tokens corresponding to the candidate response to the input query; and
identify a token location within the candidate response at which at least one incorrect token is to be replaced based on the verifying.

14. The processing system of claim 13, wherein to generate the one or more guidance signals, the one or more processors are configured to cause the processing system to generate a replacement sequence of tokens using the second generative artificial intelligence model for at least one incorrect token identified within the candidate response.

15. The processing system of claim 12, wherein the one or more guidance signals comprise signals usable by the first generative artificial intelligence model to revise the candidate response.

16. The processing system of claim 15, wherein the signals usable by the first generative artificial intelligence model to revise the candidate response comprise one or more structured grammar commands instructing the first generative artificial intelligence model to revise the candidate response according to one or more rules.

17. The processing system of claim 15, wherein the signals usable by the first generative artificial intelligence model to revise the candidate response comprise a natural language command instructing the first generative artificial intelligence model to revise the candidate response according to one or more rules.

18. The processing system of claim 12, wherein to generate the one or more guidance signals, the one or more processors are configured to cause the processing system to:
determine that the candidate response is a semantically acceptable response to the input query; and
generate an indication that the candidate response is semantically acceptable as the one or more guidance signals.

19. A processor-implemented method, comprising:
generating, based on an input query and a first generative artificial intelligence model, a sequence of tokens corresponding to a candidate response to the input query;
outputting, to a second generative artificial intelligence model, the sequence of tokens and the input query for verification;
receiving, from the second generative artificial intelligence model, one or more first guidance signals for the generated sequence of tokens;
revising the candidate response to the input query based on the generated sequence of tokens and the one or more first guidance signals; and
outputting the revised candidate response as a response to the input query.

20. The method of claim 19, wherein the one or more first guidance signals identify a token location within the candidate response at which at least one incorrect token is to be replaced.

21. The method of claim 20, wherein revising the candidate response to the input query comprises:
generating a second candidate response based on the generated sequence of tokens and the one or more first guidance signals;
outputting, to the second generative artificial intelligence model, tokens corresponding to the second candidate response;
receiving one or more second guidance signals for the tokens corresponding to the second candidate response; and
generating a third candidate response based on the tokens corresponding to the second candidate response and the one or more second guidance signals.

22. The method of claim 21, wherein the second candidate response replaces the at least one incorrect token with replacement tokens included in the one or more first guidance signals.

23. The method of claim 21, wherein:
the one or more second guidance signals indicate that the second candidate response is a semantically acceptable response to the input query; and
outputting the revised candidate response as the response to the input query comprises outputting the second candidate response as the response to the input query.

24. The method of claim 19, wherein the one or more first guidance signals comprise one or more signals including instructions for the first generative artificial intelligence model to use in generating the revised candidate response.

25. The method of claim 24, wherein one or more signals comprise one or more structured grammar commands instructing the first generative artificial intelligence model to generate the revised candidate response according to one or more rules.

26. The method of claim 24, wherein the one or more signals comprise a natural language command instructing the first generative artificial intelligence model to generate the revised candidate response according to one or more rules.

27. The method of claim 19, wherein:
revising the candidate response to the input query comprises determining that a threshold number of revisions have been performed with respect to a response generated by the first generative artificial intelligence model to the input query; and
outputting the revised candidate response comprises outputting the candidate response as the response to the input query based on determining that the threshold number of revisions have been performed.

28. The method of claim 19, further comprising:
outputting, to the second generative artificial intelligence model, the input query; and
receiving, from the second generative artificial intelligence model, information identifying a list of actions to be performed by the first generative artificial intelligence model to generate the candidate response, wherein the candidate response is generated further based on the list of actions.

29. The method of claim 19, wherein the first generative artificial intelligence model comprises a model executing on a local device, and wherein the second artificial intelligence model comprises a model executing on a device remote from the local device.

30. A processor-implemented method, comprising:
receiving, from a first generative artificial intelligence model operates, an input query and a sequence of tokens corresponding to a candidate response to the input query;
generating, using a second generative artificial intelligence model, one or more guidance signals for the first generative artificial intelligence model to use in revising one or more tokens in the sequence of tokens corresponding to the candidate response to the input query; and
outputting the one or more guidance signals to the first generative artificial intelligence model for revising the candidate response to the input query.

31. The method of claim 30, wherein generating the one or more guidance signals comprises:
verifying tokens in the sequence of tokens corresponding to the candidate response to the input query; and
identifying a token location within the candidate response at which at least one incorrect token is to be replaced based on the verifying.

32. The method of claim 31, wherein generating the one or more guidance signals comprises generating a replacement sequence of tokens using the second generative artificial intelligence model for at least one incorrect token identified within the candidate response.

33. The method of claim 30, wherein the one or more guidance signals comprise signals usable by the first generative artificial intelligence model to revise the candidate response.

34. The method of claim 33, wherein the signals usable by the first generative artificial intelligence model to revise the candidate response comprise one or more structured grammar commands instructing the first generative artificial intelligence model to revise the candidate response according to one or more rules.

35. The method of claim 33, wherein the signals usable by the first generative artificial intelligence model to revise the candidate response comprise a natural language command instructing the first generative artificial intelligence model to revise the candidate response according to one or more rules.

36. The method of claim 30, wherein generating the one or more guidance signals comprises:
determining that the candidate response is a semantically acceptable response to the input query; and
generating an indication that the candidate response is semantically acceptable as the one or more guidance signals.
